(19) United States
(12) Patent Application Publication
(10) Pub. No.: US 2017/0142272 A1
(43) Pub. Date: May 18, 2017

(54) SCAN BOUNDARY INDICATION APPARATUS AND METHOD

(71) Applicant: KYOCERA DOCUMENT SOLUTIONS, INC., Osaka (JP)

(72) Inventor: Tommy Yue, Concord, CA (US)

(73) Assignee: KYOCERA DOCUMENT SOLUTIONS, INC., Osaka (JP)

(21) Appl. No.: 14/944,235

(22) Filed: Nov. 18, 2015

(51) Int. Cl. H04N 1/00; H04N 1/028

(52) U.S. Cl. CPC H04N 1/00708; H04N 1/00795; H04N 1/02815; H04N 1/00352; H04N 1/00411; H04N 2201/0094; H04N 2201/0081; H04N 2201/0416

(57) ABSTRACT

A scan boundary indication apparatus and method includes a light source assembly with one or more light sources. A control unit calculates an amount of movement by both a first light source in a first direction and a second light source in a second direction. The control unit moves the light sources to illuminate boundaries of an original media object based on a user-selected scan size.

### BACKGROUND

The present invention relates generally to image forming apparatuses and methods and more specifically to image forming apparatuses and methods for performing original document media boundary scans, that is, to check or determine original or document boundaries.

Many users typically use image forming apparatuses to copy or scan original document media. A user that wishes to copy or scan an original document media begins by placing that document on a document receiving surface of the image forming apparatus. An image forming apparatus might be a copier, scanner, multifunction device, etc.

Often, the original document media is a regular sized document. For example, the original document size may be an 8.5 by 11 inches, A4, etc. The user places the regular-sized original document media on the document receiving surface, selects a paper size corresponding to the original document and then begins the scanning or copying operation.

At other times, the user might wish to scan an irregular-sized original document. The dimensions of an irregular-sized original document are not standard. The user also begins by placing the irregular-sized original on the document receiving surface. The user then selects an appropriate scan or paper size after which the irregular-sized original document is scanned and its image output on the paper size selected by the user. Here, the user might then realize that the selected scan size or output paper does not match the size of the irregular original document. That is, parts of the original document may be cut off in the output document.

The user then discards the printed document and begins the scanning operation again. The user places the irregular-sized document on the document receiving surface, selects a corresponding paper size for the scanning operation and then scans the document again.

Upon viewing the output document, the user may again realize that an appropriate size or appropriate scan size was not selected to match the original document. The user must then again discard the printed paper. The user then repeats the process over again until a scan size that matches the irregular original document is selected such that the user is satisfied with the output.

It is within the aforementioned context that a need for the present invention has arisen. Thus, there is a need to address one or more of the foregoing disadvantages of conventional systems and methods, and the present invention meets this need.

### BRIEF SUMMARY

In a first embodiment, a light source assembly comprises a first light source movable in a first direction, a second light source movable in a second direction; and a control unit that determines an amount of movement travelled by both the first light source in the first direction and the second light source in the second direction; wherein the control unit initiates the movement in the first direction and in the second direction, wherein said movement in the first direction moves the first light source to illuminate a first boundary of a scan size selected for scanning and/or copying the document, said first boundary being indicated on a document receiving surface on which the document is placed and wherein said movement in the second direction moves the second light source to illuminate a second boundary of the document scan size, said second boundary being indicated on the document receiving surface.

In a second embodiment, a method comprises providing a first light source movable in a first direction, and a second light source movable in a second direction; and using a control unit to determine an amount of movement travelled by both the first light source in the first direction and the second light source in the second direction; and using the control unit to initiate movement in the first direction and in the second direction wherein said movement in the first direction moves the first light source to illuminate a first boundary of a scan size selected for scanning and/or copying the document, said first boundary being indicated on a document receiving surface on which the document is placed and wherein said movement in the second direction moves the second light source to illuminate a second boundary of the document scan size, said second boundary being indicated on the document receiving surface.

In a third embodiment, a light source assembly for an image forming apparatus, the image forming apparatus for scanning and/or copying a document, the light source assembly comprises a first light source that illuminates a boundary of a scan or copy size selected for the document wherein the first light source is movable in a first direction; a control unit that determines an amount of movement travelled by the first light source in the first direction from a rest position of the first light source to a target position of the first light source; and wherein the control unit initiates movement in the first direction to move the first light source from said rest position of the first light source to said target position of the first light source to illuminate a first boundary of the selected scan size wherein the first light source travels in the first direction but illuminates the boundary of the selected scan size in a different direction.

A further understanding of the nature and advantages of the present invention herein may be realized by reference to the remaining portions of the specification and the attached drawings. Further features and advantages of the present invention, as well as the structure and operation of various embodiments of the present invention, are described in detail below with respect to the accompanying drawings. In the drawings, the same reference numbers indicate identical or functionally similar elements.

### BRIEF DESCRIPTION OF THE DRAWINGS

FIG. 1A illustrates an image forming apparatus according to an exemplary embodiment of the present invention.

FIG. 1B illustrates components of the image forming apparatus of FIG. 1A according to an exemplary embodiment of the present invention.

FIG. 2 illustrates scan size buttons according to an exemplary embodiment of the present invention.

FIG. 3 illustrates alternate scan size buttons according to another exemplary embodiment of the present invention.

FIG. 4 illustrates a location of the check scan boundary button and check scan boundary releaser of FIG. 1B according to an exemplary embodiment of the present invention.

FIG. 5 illustrates mounting of vertical and horizontal light sources according to an exemplary embodiment of the present invention.

FIG. 6 illustrates operation of the vertical and horizontal light sources according to an exemplary embodiment of the present invention.

FIG. 7 illustrates operation of the vertical and horizontal light sources according to an exemplary embodiment of the present invention.

FIG. 8 illustrates boundary scan process flow according to an exemplary embodiment of the present invention.

FIG. 9 illustrates an alternative image forming apparatus according to an exemplary embodiment of the present invention.

FIG. 10 illustrates an exemplary computer system architecture for use with an exemplary embodiment of the present invention.

### DETAILED DESCRIPTION

Reference will now be made in detail to the embodiments of the invention, examples of which are illustrated in the accompanying drawings. While the invention will be described in conjunction with the one embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of the present invention, numerous specific details are set forth to provide a thorough understanding of the present invention. However, it will be obvious to one of ordinary skill in the art that the present invention may be practiced without these specific details. In other instances, well-known methods, procedures, components, and circuits have not been described in detail as to not unnecessarily obscure aspects of the present invention.

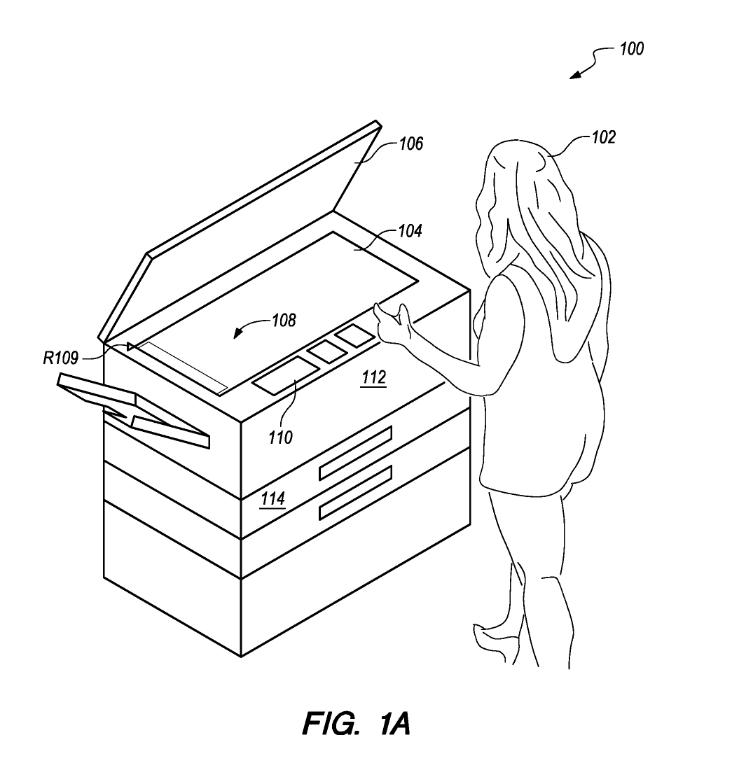

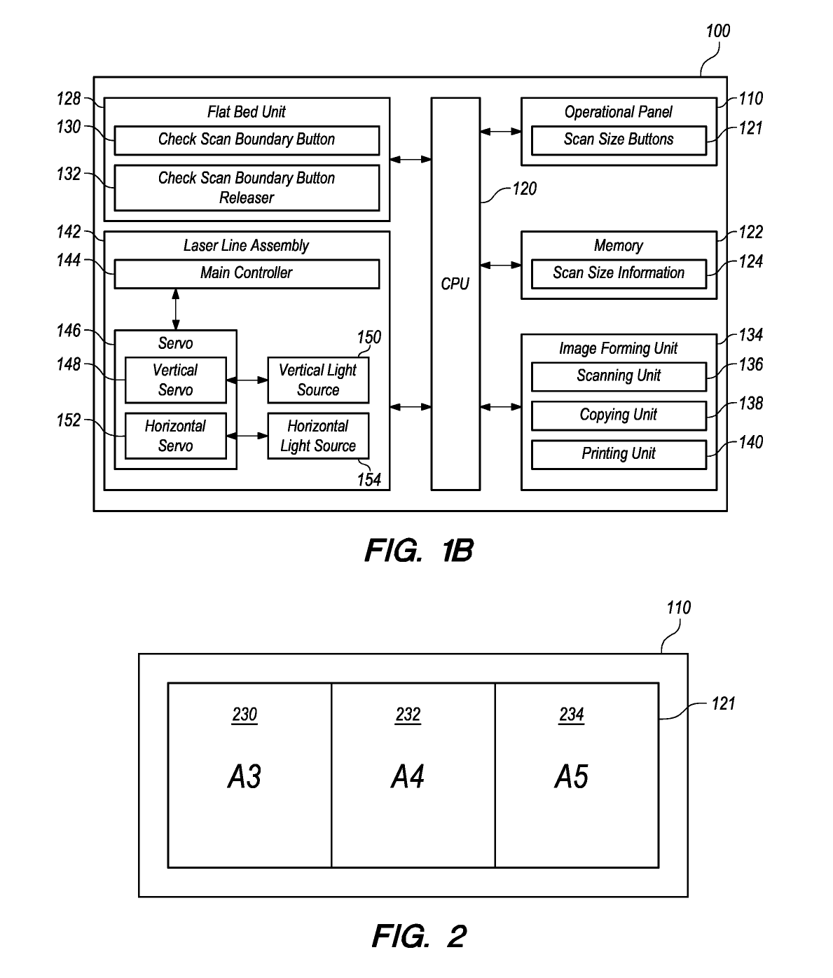

FIG. 1A illustrates image forming apparatus 100 according to an exemplary embodiment of the present invention.

In FIG. 1A, among other functionalities, user 102 may employ image forming apparatus 100 to copy and/or scan original documents and media objects as well as to check scan boundaries before said document or media objects are copied or scanned. Unlike conventional systems, user 102 may not need to repeat the copying and/or scanning of irregular-sized original documents multiple times to obtain a desired paper size for the output.

As shown in FIG. 1A, image forming apparatus 100 includes document receiving surface 104 and cover 106, which can be opened and lowered over document receiving surface 104. Document receiving surface 104 might be platen glass or other comparable transparent material consistent with the spirit and scope of the present invention. Original documents—either standard sized or irregular or other media types for scanning and/or copying—can be placed on document receiving surface 104.

Image forming apparatus 100 further comprises image reading unit 108 and operational panel 110 operable by user 102 for initiating copying, scanning, and /or scan boundary checking in accordance with the embodiments of the present invention. As shown, image reading unit 108 is disposed underneath document receiving surface 104, and is movable to copy and/or scan original documents.

Image forming apparatus 100 further includes main body 112 and a plurality of paper trays 114 holding standard-sized papers that correspond to original document sizes to be copied and/or scanned. Although not shown, the interior of main body 112 includes a paper discharge section; and an image forming unit, a CPU and a laser line assembly that will be discussed with reference to FIG. 1B. Operation of image forming apparatus 100 will now be briefly described.

In operation, user 102 begins by placing an original document on document receiving surface 104 ensuring that the original document edge is aligned with reference mark R109. However, R109 can be conveniently located at other corners or sides of document receiving surface 104. User 102 is now ready to begin a copying or scanning operation. However, if the original document is not a standard size (i.e., 8.5×11 or 8.5×14 inches), prior to this scanning or copying operation, user 102 may wish to perform a boundary scan check of the document to be copied or scanned.

A check boundary scan button (not shown) on operation panel 110 may be selected by user 102 to initiate the check scanning boundary operation that determines whether a copy or scan paper size selected by the user corresponds or is appropriate for the document that is being scanned or copied.

If the check boundary scan determines that the original document size matches the selected scan size, user 102 can then begin a scanning or copying operation as needed. Further elements of operation and components of the present invention will be described below with reference to FIGS. 1B to 7.

FIG. 1B illustrates image forming apparatus 100 of FIG. 1A according to an exemplary embodiment of the present invention.

In FIG. 1B, among other components, image forming apparatus 100 comprises CPU 120 communicatively coupled to other components including operation panel 110 and memory 122 for data storage; memory 122 generally has volatile random access memory and read only memory that facilitate processing of instructions by CPU 120.

More specifically, memory 122 includes scan size information 124, which holds scan size information selected by user 102. That is, operation panel 110 includes scan size buttons 121 that can be selected by user 102 to select particular scan sizes for an original document prior to a scanning or copying operation. This scan size information is stored in memory by scan size information 124 as further illustrated in FIG. 2.

FIG. 2 illustrates operation panel 110 with scan size buttons 121 according to an exemplary embodiment of the present invention.

In FIG. 2, scan size buttons 121 are embedded hard buttons within operation panel 110 that enable user 102 to select appropriate standard sizes. Prior to a scanning operation user 102 may begin by selecting scan button 232 for standard size A4, and then determines that A4 is too large, user 102 can then select smaller size A5 by selecting scan size button 234.

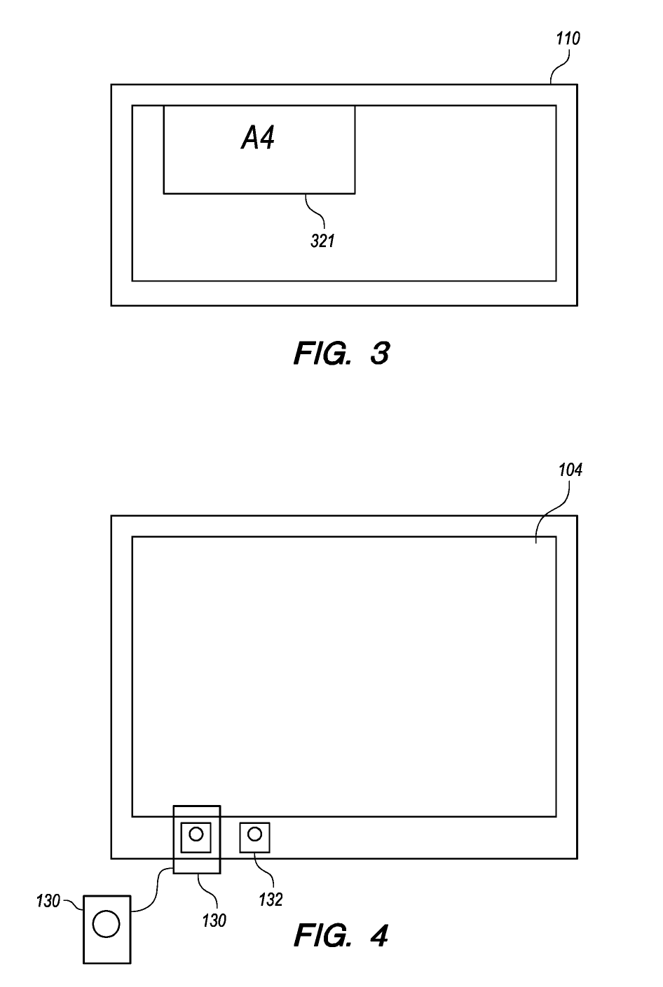

FIG. 3 illustrates alternate operation panel 110 with scan size button 321 according to another exemplary embodiment of the present invention.

In FIG. 3, operation panel 110 is a touch screen displaying scan size buttons such as scan size button 321 corresponding to respective regular paper sizes.

Referring now to FIG. 1B, imaging forming apparatus 100 further comprises flatbed unit 128 that includes check scan boundary button 130 as well as check scan boundary button releaser 132. When user 102 selects check scan boundary button 130, the scan boundary checking process is initiated. This boundary checking process checks a first boundary of the scan size selected for scanning or copying of an original media document. As implied by its name, check scan boundary button releaser 132 releases the check scan boundary button 130 and terminates the scan boundary checking process.

FIG. 4 illustrates a location of check scan boundary button 130 and check scan boundary releaser 132 according to an exemplary embodiment of the present invention.

In FIG. 4, specifically, check scan boundary button 130 and check scan boundary button releaser 132 are located on a panel adjacent to document receiving surface 104. In this manner, the buttons are easily accessible and selectable by user 102. Variations for initiating and terminating scan boundary checking are possible.

In one embodiment, there is no check scan boundary releaser 132. In such a case, user 102 may select and continue to hold down check scan boundary button 130 until the check scan boundary operation is completed, after which check scan boundary button 130 is released to terminate the check scan boundary operation.

In another embodiment, check scan boundary button 130 initiates and terminates the scan boundary checking process. Specifically, check scan boundary button 130 may be pressed to initiate operation and can then be pressed again to terminate operation. In further embodiments, check scan boundary button 130 and check scan boundary button releaser 132 can be initiated and/or released by opening and/or closing cover 106 of FIG. 1A.

For example, when cover 106 is closed, check scan boundary button releaser 132 may be selected to terminate the check scan boundary operation. In another embodiment, when cover 106 is closed, a releasing unit may be configured to automatically release the check scan boundary button according to the detected result from a detecting unit. In another embodiment, the releasing unit is embedded on the cover 106 so that the releasing unit protrudes toward platen glass (that is, downward direction) and can push the scan boundary button to release, when the cover 106 is closed.

Referring now to FIG. 1B, image forming apparatus 100 further includes image forming unit 134 that forms the image of the original document on media such as paper. Image forming unit 134 further includes scanning unit 136, copying unit 138, and printing unit 140.

In FIG. 1B, image forming apparatus 100 further comprises laser line assembly 142 that includes main controller 144 coupled to servo 146. Within laser line assembly 142, servo 146 itself comprises vertical servo 148 operatively coupled to move a first or vertical light source 150 based on an amount estimated by main controller 144. Servo 146 also includes second or horizontal servo 152 operatively coupled to move a second or horizontal light source 154 based on an amount determined by main controller 144.

Here, vertical light source 150 and horizontal light source 154 can be any light source type that is consistent with the spirit and scope of the present invention. Preferably, however, vertical light source 150 and light source 154 are laser light sources.

Laser light sources are preferable because they differ from other light sources in that lasers emit light that is coherent and collimated. This spatial coherency and collimation enables light sources 150 and 154 to emit narrow light beams that are focused and avoid the divergence associated with other light sources. In this manner, light emitted from the light sources can better illuminate original media objects in the light path and also avoid reflection of light into the eyes of user 102.

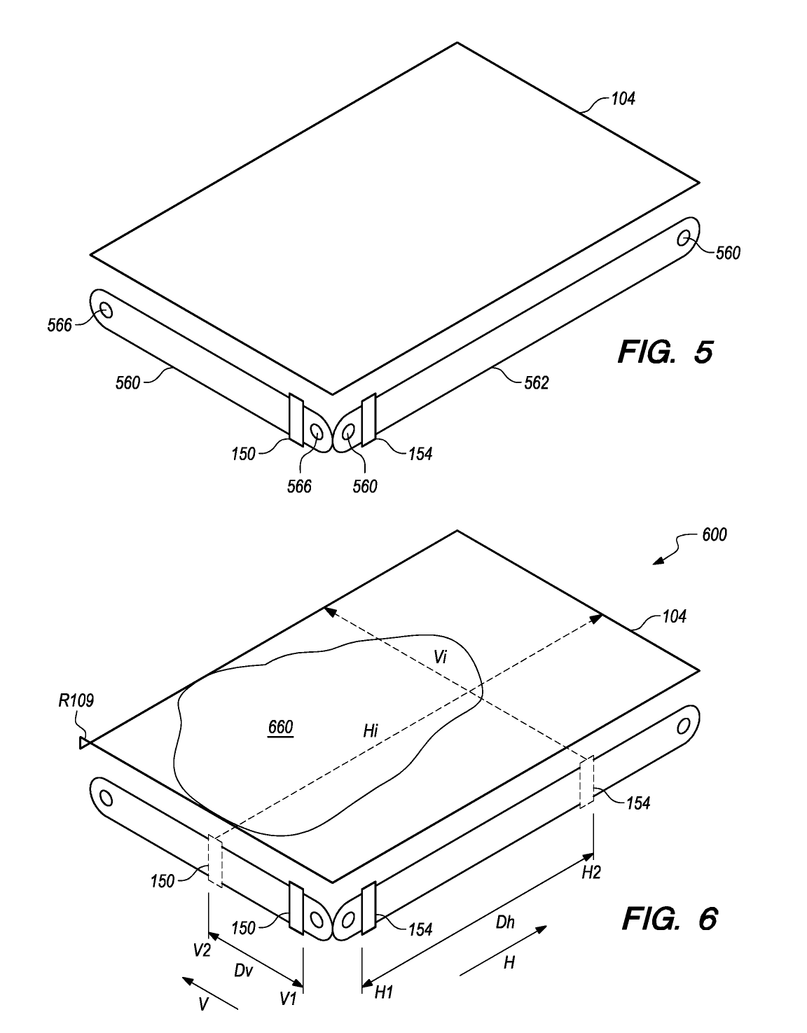

Referring now to FIG. 1B, as noted, main controller 144 calculates an amount of movement and directs the horizontal and vertical servos to move vertical light source 150 and light source 154, which are coupled (not shown) to the horizontal and vertical servos. Vertical light source 150 and light source 154 are movable by belts as illustrated in FIG. 5.

FIG. 5 illustrates mounting of light sources 150 and 154 according to an exemplary embodiment of the present invention.

In FIG. 5, specifically, vertical light source 150 is mounted on rotatable belt 560 while light source 154 is mounted on rotatable belt 562. Rotatable belt 560 is mounted around plural wheels 566 permitting rotation of rotatable belt 560 on plural wheels 560. Rotatable belt 562 is mounted around plural wheels 560 permitting rotation of rotatable belt 562 on plural wheels 560. Both belt and wheel-mounted light sources are then installed under receiving document surface 104 as shown.

When directed by the main controller 144 (of FIG. 1B), horizontal servo 152 (of FIG. 1B) engages plural wheel 560 and rotatable belt 562 to move horizontal light source 154 based on the scan size selected by the user, and to illuminate a boundary upon reaching a target position.

Main controller 144 similarly directs vertical servo 148 (of FIG. 1B) to engage plural wheels 566 and rotatable belt 560 to advance vertical light source 150 based on the scan size and to illuminate a boundary upon reaching a target position. Note that alternatively, the laser line assembly may be controlled by CPU 120 and not main controller 144. Calculation of the movement of the assembly may be also performed by CPU 120.

Operation of image forming apparatus 100 will now be described with reference to FIG. 6 through FIG. 9.

In operation, user 102, wishing to make a copy or scan of irregular-sized original 660 (of FIG. 6) would begin by placing irregular-sized original 660 on document receiving surface 104. Irregular-sized original 660 is then aligned with reference to mark R109 on document receiving surface 104.

User 102 is now ready to copy or scan irregular-sized original 660. Unlike conventional systems where user 102 begins to directly make copies by selecting a paper size corresponding to irregular-sized original 660 and then scanning or copying for several cycles until a satisfactory paper size that matches the irregular-sized document is obtained, the present invention allows user 102 to scan the boundaries of an irregular-sized original before the actual copying or scanning operation is started.

In this manner, considerable time and effort are saved by avoiding several cycles of copying and scanning by determining an appropriate paper size before the actual copying or scanning process is started. A copying or scanning operation that would take a few seconds using the present invention would take several minutes using conventional imaging systems. Moreover, in an environmentally conscious world, considerable waste of paper or other media is avoided because the copy or scan is made only once, avoiding waste of paper that occurs from making several unwanted copies using conventional systems.

After irregular-sized original 660 is placed on document receiving surface 104, user 102 initiates the copy or scanning process by selecting scan size button 121 (of FIG. 1B or FIG. 2). Specifically, user 102 selects a standard size (such as A4) by selecting scan size button 232. The selected size is then stored into memory by scan size information 124 (of FIG. 1B).

Upon scan size selection, user 102 then initiates the scan boundary operation by pressing check scan boundary button 130. Upon receiving the user input signal from user 102, main controller 144 of FIG. 2 calculates an amount of movement travelled by vertical light source 150 in the vertical direction V. This vertical direction V is shown in FIG. 6. The amount of movement Dv by vertical light source 150 is also shown in FIG. 6. Specifically, vertical light source 150 travels the amount Dv from a rest position V1 to a final or target position V2 in FIG. 6.

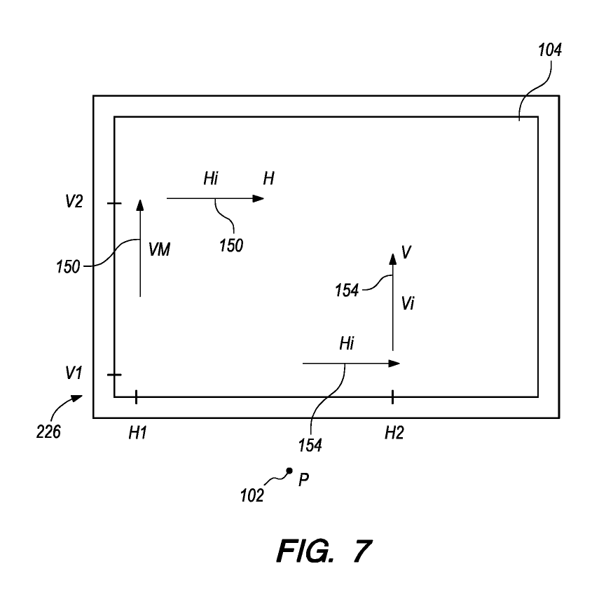

At target position V2, vertical light source 150 illuminates the horizontal boundary (direction Hi) of irregular-sized original 660. In this manner, user 102 can begin to determine whether the selected scan size is acceptable. The direction of illumination Hi and the direction V of movement of vertical light source 150 are substantially perpendicular. That is, the direction of illumination is horizontal while the direction of movement is vertical as further discussed with reference to FIG. 7.

Although not necessary, rest position V1 and reference mark R109 may coincide. However, rest position V1 may be located elsewhere along the vertical axis in direction V.

Here, as shown, the position of rest position V1 does not coincide with reference mark R109. Here, R109 is located on the upper left hand corner of document receiving surface 104 (with respect to a user standing in front of the image forming apparatus 10) while rest position VI is located on the lower left corner of document receiving surface 104. In such a case, the amount of movement (distance in vertical direction) Dv traveled by vertical light source 150 is the vertical length of the document receiving surface 104 minus the length of the vertical side of the selected scan or paper size (not shown). For example, if the selected paper scan size is A4, then the amount of movement Dv is the length of the vertical side of document receiving surface 104 minus 210 mm or 8.27 inches.

After travelling by the amount of movement Dv, vertical light source 150 arrives at target position V2. That is, target position V2 depends upon the amount of movement Dv by vertical light source 150 in the vertical direction V.

Preferably, target position V2 is configured to coincide with the horizontal edge of the selected scan or paper size. As previously noted, at target position V2, vertical light source 150 emits scan lines that illuminate the horizontal boundary (Hi direction) of irregular-sized original 660. The scan lines determine the scan area for the irregular-sized original 660.

Although the emitted scan line is not normally visible, if any portion of irregular-sized original 660 or any other scanning media falls above the scan line, the scan line would be visible to user 102 since the scan line is cast onto irregular-sized original 660. In this manner, user 102 knows how much of irregular-sized original 660 is being cut off so that user 102 can select a scan size that matches irregular-sized original 660 within the scanning area. Note also that user 102 can choose any preferable size if the user doesn't need some portion outside the indicated boundaries to scan/print.

The corollary is if irregular-sized original 660 fits entirely within the scan area, although user 102 cannot observe the scan line, user 102 knows that irregular-sized original 660 is within the scan boundary (since the scan lines are not visible). In that case, user 102 selects a different scan size that's smaller to match irregular-sized original 660.

Referring to FIG. 6, in addition to calculating an amount of movement traveled by vertical light source 150, main controller 144 contemporaneously determines an amount of movement (or distance in horizontal direction) Dh traveled by horizontal light source 154 in the horizontal direction H. The amount of movement Dh is from a rest position H1 to a final or target position H2.

Upon arrival at target position H2, horizontal light source 154 is triggered and illuminates the vertical boundary Hi of irregular-sized original 660. The vertical boundary is illuminated to determine the scan area for the irregular-sized original 660. If irregular-sized original 660 is within the scan area, emitted light or light emitted from original light source 154 will not be visible to user 102.

If irregular-sized original 660 is beyond the scan area, user 102 can observe light emitted from horizontal light source 154 and can therefore make adjustments to horizontal light source 154. Specifically, user 102 can select a different paper size that appropriately matches irregular-sized original 660.

Although not necessary, rest position H1 and reference mark R109 of FIG. 1A may coincide. However, rest position H1 may also be at any point along the horizontal axis in direction H.

If rest position H1 and reference mark R109 coincide, the longest amount of movement Dh traveled by horizontal light source 154 is the length of the horizontal side of the selected scan size. For example, if rest position H1 and reference mark R109 coincide, and the selected scan paper size is A4, then the amount of movement Dh in the horizontal direction H is about 297 mm or 11.69 inches.

If rest position H1 and reference mark R109 do not coincide and the rest position H1 is further along the horizontal axis before the end of the length of a horizontal side of the selected scan size, then the longest amount of movement Dh by horizontal light source 154 is less than the length of a horizontal side of the selected scan size.

The target position H2 of horizontal light source 154 is reached after an amount of movement Dh is traveled by horizontal light source 154, which amount is determined by the scan size selected by user 102 and by rest position H1. Target position H2 is also dependent upon the amount of movement Dh by horizontal light source 154 in the horizontal direction.

For example, if the selected scan size is A4 and the rest position H1 is at reference mark R109, then the target position H2 is about 297 mm or 11.69 inches. Preferably, target position H2 is configured to coincide with the vertical edge of the selected scan or paper size.

Another advantage of the present invention is that the direction of illumination of both light sources is away from user 102. Thus, in FIG. 7, the direction of illumination Vi of horizontal light source 154 is in a vertical direction V as shown in FIG. 7. This arrangement proves useful because the direction of illumination Vi in the vertical direction V is away from user 102 positioned at P in front of document receiving surface 104. At this position P, light is directed away from and does not reflect into the user's eyes.

Similarly, the direction of illumination Hi of vertical light source 150 is away from user 102. Specifically, the direction of light emitted by vertical light source 150 is horizontal H as shown in FIG. 7.

Another aspect of the present invention is that the direction of illumination Hi and the direction of movement Vm of vertical light source 150 are substantially perpendicular, since Hi is horizontal and Vm is vertical as shown in FIG. 7. Similarly for horizontal light source 154, the direction of illumination Vi and the direction of movement Hm are also substantially perpendicular. In short, both vertical light source 150 and horizontal light source 154 travel in a direction different from their direction of illumination.

Note that the direction of illumination and the direction of movement need not be substantially perpendicular. However, it is preferred that the direction of illumination and the direction of movement remain substantially perpendicular because both light sources can directly move from their rest to their target positions. Upon reaching the target positions, the direction of illumination is then along the edges of the selected scan size. In this manner, a substantially perpendicular angle between the directions of illumination and movement is obtained.

Referring to FIG. 1B, after main controller 144 has determined an amount of movement by both light sources, it directs vertical servo 148 to move vertical light source 150 from rest position V1 to target position V2 (of FIG. 6) based on the calculated amount of movement. Contemporaneously, horizontal servo 152 is directed to move horizontal light source 154 in the horizontal direction by the amount determined by main controller 144.

After vertical and horizontal light sources 150 and 154 reach their target positions and illuminate corresponding boundaries of the selected scan size, user 102 can then determine whether the selected scan size matches the irregular-sized original 660 and may make adjustments as necessary.

If satisfied with the selected scan size, user 102 can now begin the copying or scanning process. In particular, user 102 uses a start button (not shown) to initiate image forming unit 134 which forms the image of irregular-sized original 660. Printing unit 140 then prints out the formed image for output.

As stated earlier, unlike traditional systems where user 102 runs through several cycles of copying or scanning an irregular-sized original 660 before obtaining a satisfactory print, the system and method of the present invention facilitates quicker copying or scanning by enabling user 102 to scan boundaries of irregular-sized originals before the actual copying or scanning operation is started.

In this manner, considerable time and effort are saved by avoiding several cycles of copying and scanning by determining an appropriate paper size before the actual copying or scanning process is started. A copy or scanning operation would thus take less time and conserve media resources that are valuable for the environment.

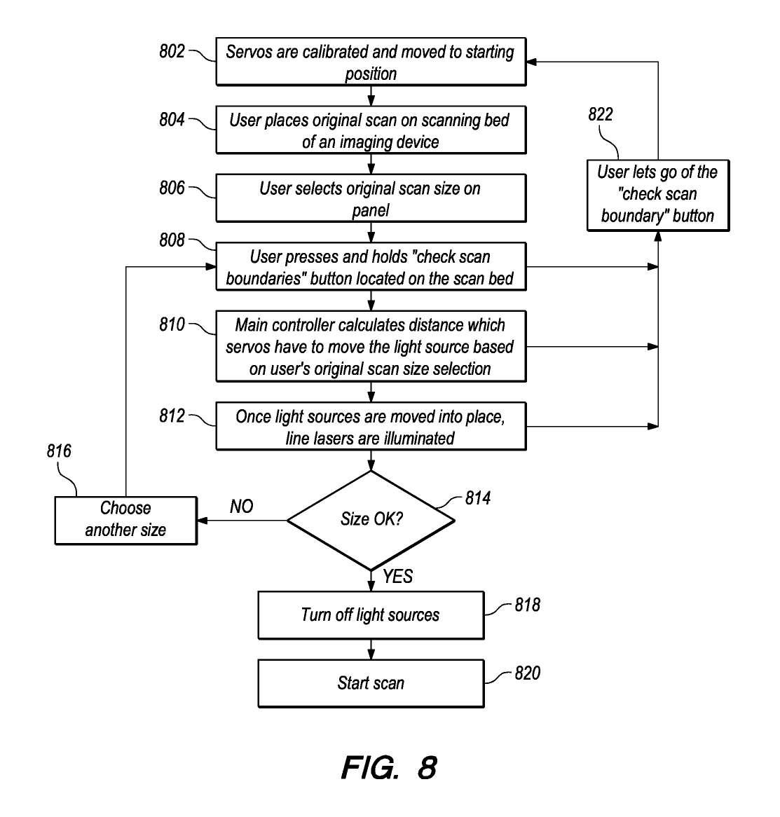

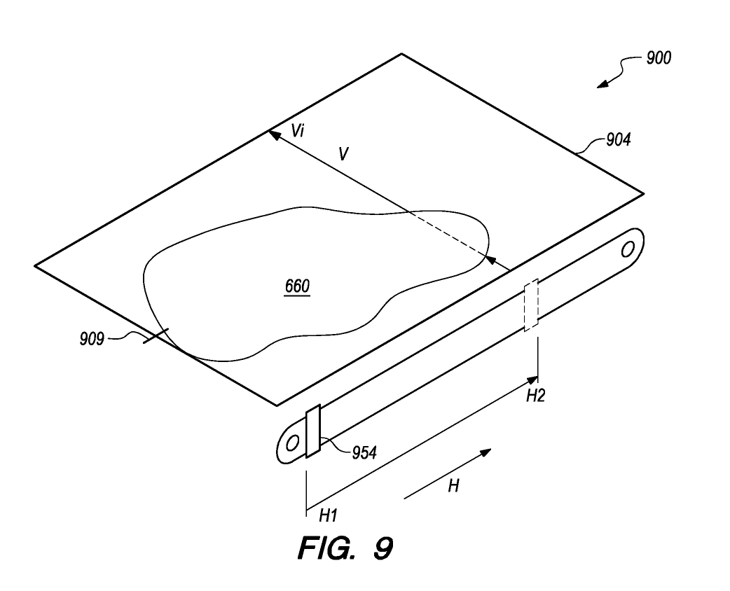

FIG. 8 illustrates a method depicting boundary scan process flow according to an exemplary embodiment of the present invention.

At block 802, vertical servo 148 and horizontal servo 152 (of FIG. 1B) are calibrated and moved to a start position (not shown).

At block 804, user 102 places irregular-sized original 660 (of FIG. 6) on document receiving surface 104 (of FIG. 6).

At block 806, user 102 selects an original scan size button (e.g., scan size 230 of FIG. 2 or scan size button 321 of FIG. 3).

At block 808, user 102 presses and holds check scan boundary boundaries button 130 (of FIG. 1A).

At block 810, main controller 144 (of FIG. 1B) calculates an amount of movement traveled by vertical light source 150 and horizontal light source 154 (of FIG. 1A and FIG. 7) based on user 102's scan size selection. Vertical servo 148 and horizontal servo 152 move their respective light sources to respective target positions.

At block 812, vertical light source 150 and horizontal light source 154 reach their target positions and illuminate the boundaries of the selected scan size. Note that flow proceeds to block 822 if during block 808, block 810 or block 812, user 102 releases the check scan boundary button 130, after which method 800 returns to block 802.

At decision block 814, user 102 determines whether the original scan size selected is appropriate for or matches irregular-sized original 660. If not, method 800 proceeds to 816, where user 102 selects another scan size. After another size is selected, flow then returns to block 808.

At decision block 814, if user 102 determines that the selected scan size is appropriate for irregular-sized original 660, then flow proceeds to block 818 to turn off the light sources and thereafter to block 820, where user 102 initiates a copying or scanning operation.

While the above is a complete description of exemplary specific embodiments of the invention, additional embodiments are also possible. For example, although the image forming apparatus 100 has been described with reference to two light sources, image forming apparatus may have only a single light source as illustrated with reference to FIG. 9.

FIG. 9 illustrates image forming apparatus 900 according to an exemplary embodiment of the present invention.

In FIG. 9, image forming apparatus 900 comprises only a single light source 954, which travels in horizontal direction H. Image forming apparatus 900 further includes document receiving surface 904. Unlike previous embodiments, document receiving surface 904 has a reference mark 909 that is centered on the vertical axis of the document receiving surface 904. Thus, irregular-sized original 660 to be copied or scanned is centered on document receiving surface 904 using reference position 909 as a guide.

Here, horizontal light source 954 travels the length or horizontal direction of document receiving surface 904 from rest position H1 to target position H2 to illuminate irregular-sized original 660 in the vertical direction V. That is, the direction of illumination Vi is substantially perpendicular to the movement direction from V1 to V2.

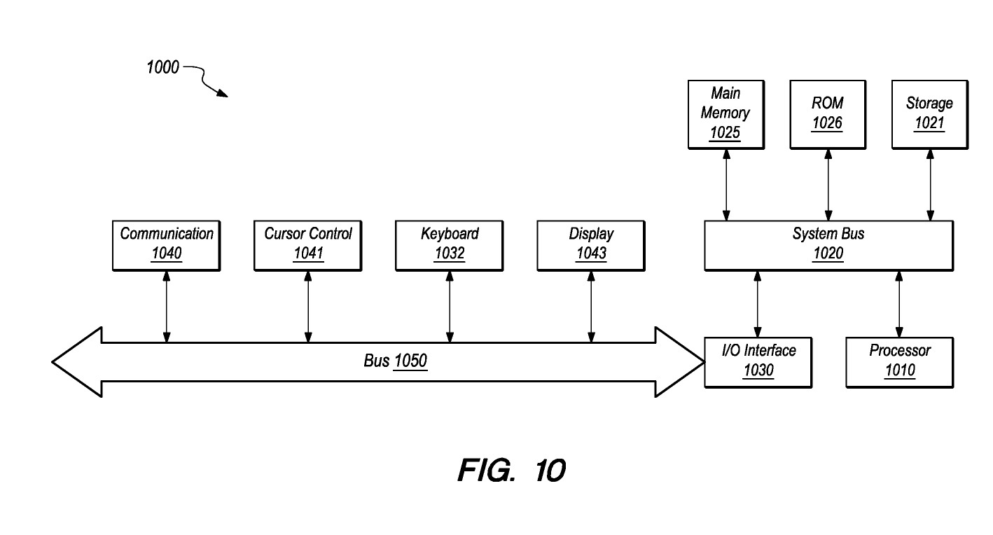

An advantage of the present invention is that no vertical light source is employed since the boundary scanning process is only based on the horizontal length of the selected scan size. As an example, if user 102 selects scan size A4, horizontal light source 954 need only move about 297 mm or 11.69 inches from rest position H1 to target position 2. Therefore, because no vertical light source is employed, fewer components are needed thus simplifying image forming apparatus 900 of the present embodiment. FIG. 10 illustrates computer system architecture 1000 for use with an exemplary embodiment of the present invention.

In one embodiment, computer system architecture 1000 comprises system bus 1020 for communicating information and processor 1010 coupled to system bus 1020 for processing information. Computer system architecture 1000 further comprises a random access memory (RAM) or other dynamic storage device 1025 (referred to herein as main memory), coupled to system bus 1020 for storing information and instructions to be executed by processor 1010. Main memory 1025 may also be used for storing temporary variables or other intermediate information during execution of instructions by processor 1010. Computer system architecture 1000 may also include a read only memory (ROM) and/or other static storage device 1026 coupled to system bus 1020 for storing static information and instructions used by processor 1010.

A data storage device 1021 such as a magnetic disk or optical disc and its corresponding drive may also be coupled to system bus 1020 for storing information and instructions. Computer system architecture 1000 can also include a second bus 1050 coupled via I/O interface 1030 to system bus 1020. A plurality of I/O devices may be coupled to bus 1050, including display device 1043, an input device (e.g., alphanumeric input device 1032 and/or cursor control device 1041).

Communication device 1040 allows for access to other computers (e.g., servers or clients) via a network. Communication device 1040 may comprise one or more modems, network interface cards, wireless network interfaces or other interface devices such as those used for coupling to Ethernet, token ring, or other types of networks.

Other variations are as follows:

In some embodiments, the boundaries that indicate the scan size can be shown in their entirety in each of scanned directions. In other embodiments, only a portion of the entire length of the boundaries that indicate the scan size are shown. Boundaries can be shown only for those corresponding to edges of selected paper size.

In yet other embodiments, the vertically moving structure (including vertical servo 148) may be between a scanning unit for scanning original document placed on the document receiving surface 104 (for example) and an ADF (Automatic Document Feeder) scanning unit for scanning original documents set on the ADF. The ADF scanning unit may be, for example, equipped with a CCD (Charge Coupled Device) based image scanning unit or CIS (Contact Image Sensor) based image scanning unit.

In some embodiments, rest positions of locations of the servos before starting movement to the target positions can be different from the reference mark R109 in the above described embodiments.

In some embodiments, a user can register nonstandard paper sizes based on demand. The user can choose or change order of scan size buttons displayed on the operation panel. This enables a user to choose sizes which the user expects to use more frequently to display preferentially ordered. In yet other embodiments, these buttons can be ordered automatically according to usage histogram. Yet, other example embodiments, these buttons can be displayed differently in size according to preference of the user.

In some example embodiments, the user can change laser strength and angle. This change in laser strength can be performed via the operation panel.

In one example embodiment, the user may be prompted to check scan size boundaries only when the user is determined to select a paper size which the user has never selected. In some other embodiments, the user may be prompted to check the boundaries when the user selects a paper size which the user has not frequently selected, for example, which the user has selected a certain times less than a predetermined threshold. In yet some other example embodiments, the user may be prompted to check the boundaries when the user selects a paper size which the user has selected before but has not selected recently. In these example embodiments, whether the user is prompted to check is determined based on usage history of each of user.

And this usage history information may be collected for each of printing devices. The usage history information may also be collected for a plurality of printing devices, such as all printing devices in the user's office. The usage history information may be collected for some printing devices which are located physically away from each other but managed by the same administrative entity. In this case, the usage history may be stored on the cloud server and the printing devices may access the cloud server to retrieve the usage history information for the user who logs into the printing device.

Thus, the above description should not be taken as limiting the scope of the invention, which is defined by the appended claims along with their full scope of equivalents.

1. A light source assembly comprising:
a sole first light source movable in a vertical direction,
a sole second light source movable in a horizontal direction;
an automatic scan/copy area bounded by:
a stationary horizontal boundary not defined by a light source;
a stationary vertical boundary not defined by a light source, said stationary vertical boundary being orthogonal with the stationary horizontal boundary;
a light-defined movable horizontal boundary disposed in parallel with and below the stationary horizontal boundary relative to a position of a user facing said scan/copy area, said light-defined movable boundary being defined by said sole first light source;
a light-defined movable vertical boundary;
wherein the light-defined movable vertical boundary is defined by said sole second light source positioned on a lower edge of a document receiving surface on which an original document is placed, wherein although said sole second light source moves in a horizontal direction along said lower edge to vary the scan/size area, said sole second light source illuminates in a vertical direction from said lower edge toward the stationary horizontal boundary;
a user interface for receiving a user input signal to automatically move the movable horizontal and vertical boundaries to define the scan/copy area with reference to the stationary horizontal and vertical boundaries;
a control unit that calculates, based on the user input signal, an amount of movement travelled by both the sole first light source in the vertical direction and the sole second light source in the horizontal direction; and
wherein the control unit initiates the movement in the vertical direction and in the horizontal direction, wherein said movement in the vertical direction moves the sole first light source to illuminate a first boundary of a scan size selected for scanning and/or copying the document, said first boundary being indicated on said document receiving surface on which the document is placed and wherein said movement in the horizontal direction moves the sole second light source to illuminate a second boundary of the document scan size, said second boundary being indicated on the document receiving surface.

2. (canceled)

3. (canceled)

4. (canceled)

5. (canceled)

6. (canceled)

7. The light source assembly of claim 1 wherein said movement in the vertical direction moves the first light source from a rest position that is at an intersection of the stationary vertical boundary and the lower edge of the document receiving surface to a target position located along the stationary vertical boundary.

8. The light source assembly of claim 1 wherein said movement in the horizontal direction moves the sole second light source from a rest position that is at an intersection of the stationary vertical boundary and the lower edge of the document receiving surface to a target position that is located along the lower edge of the document receiving surface.

9. The light source assembly of claim 1 wherein the sole first light source and the sole second light source are laser light sources.

10. A method comprising:
providing a sole first light source movable in a vertical direction, and a sole second light source movable in a horizontal direction;
providing a user interface for receiving a user input signal to automatically move the light sources in the vertical and horizontal directions to define horizontal and vertical boundaries for a scan/copy area with reference to a stationary horizontal boundary and a stationary vertical boundary;
using a control unit to determine an amount of movement travelled by both the sole first light source in the vertical direction and the sole second light source in the horizontal direction; and
using the control unit to initiate movement in the vertical direction and in the horizontal direction wherein said movement in the vertical direction moves the sole first light source to illuminate a first boundary of a scan size selected for scanning and/or copying the document, said first boundary being indicated on a document receiving surface on which the document is placed and wherein said movement in the horizontal direction moves the sole second light source to illuminate a second boundary of the document scan size, said second boundary being indicated on the document receiving surface.

11. (canceled)

12. (canceled)

13. A light source assembly for an image forming apparatus, the image forming apparatus for scanning and/or copying a document, the light source assembly comprising:
a sole first light source that illuminates a boundary of a scan or copy size selected for the document wherein the sole first light source is movable in a vertical direction;
a control unit that determines an amount of movement travelled by the sole first light source in the vertical direction from a rest position of the first light source that is at an intersection of a stationary vertical boundary and a lower edge of a document receiving surface to a target position located along a stationary vertical boundary; and
wherein the control unit initiates movement in the vertical direction to move the sole first light source from said rest position of the sole first light source to said target position of the sole first light source to illuminate a first boundary of the selected scan size wherein the first light source travels in the vertical direction but illuminates the boundary of the selected scan size in a different direction.

14. The light source assembly of claim 13 further comprising a sole second light source movable in a horizontal direction.

15. (canceled)

16. The light source assembly of claim 13 wherein the sole first light source travels in a direction different from a direction of illumination of the first boundary.

17. The light source assembly of claim 14 wherein the sole second light source travels in a second direction that is horizontal but illuminates the second boundary in a vertical direction.

18. The light source assembly of claim 13 wherein said movement in the vertical direction moves the first light source from a rest position to a target position of the sole first light source to illuminate the first boundary.

19. The light source assembly of claim 11 wherein said movement in the vertical direction moves the second light source from a rest position to a target position of the second light source to illuminate the second boundary.

20. The light source assembly of claim 15 wherein the second direction is horizontal.

21. The light source assembly of claim 8,
wherein the document receiving surface has a reference mark,
wherein the stationary horizontal boundary includes a first stationary horizontal boundary and a second stationary horizontal boundary in parallel with the first stationary horizontal boundary, the stationary vertical boundary includes a first stationary vertical boundary and a second stationary vertical boundary in parallel with the first stationary vertical boundary, and the automatic scan/copy area is bounded by the first stationary horizontal boundary, the second stationary horizontal boundary, the first stationary vertical boundary, and the second stationary vertical boundary,
wherein the reference mark is located at the corner of the first stationary vertical boundary and the first stationary horizontal boundary,
wherein the rest position is located at the corner of the first stationary vertical boundary and the second stationary horizontal boundary, thereby the reference mark is located at a different position from the rest position.

22. The light source assembly of claim 1, further comprising:
a check scan boundary button;
wherein the illumination of the scan boundary is configured to be initiated when the check scan boundary button is detected to be selected;
wherein the illumination of the scan boundary is configured to continue while the check scan boundary button is held down; and
wherein the illumination of the scan boundary is configured to be terminated when the check scan boundary buttons is detected to be released.

23. The light source assembly of claim 1, further comprising:
a check scan boundary button; and
a check scan boundary releaser;
wherein the illumination of the scan boundary is configured to be initiated when the check scan boundary button is detected to be selected; and
wherein the illumination of the scan boundary is configured to be terminated when the check scan boundary releaser is detected to be selected.

24. The light source assembly of claim 1, further comprising:
a check scan boundary button;
a check scan boundary releaser; and
a cover configured to open and close the document receiving surface;
wherein a releasing unit is mounted on the cover, and the releasing unit is configured to engage with the check scan boundary releaser when the cover is closed;
wherein the illumination of the scan boundary is configured to be initiated when the check scan boundary button is detected to be selected; and
wherein when the cover is closed, the releasing unit engages with the check scan boundary releaser and the illumination of the scan boundary is configured to be terminated.

25. The light source assembly of claim 1, further comprising:
memory;
wherein one or more nonstandard paper sizes are registered in the memory for respective user;
wherein the one or more nonstandard paper sizes are configured to be shown to the respective user according to usage history of the respective user.

26. The light source assembly of claim 9, wherein a laser strength and an angle of the laser light illuminated by the sole first light source and the sole second light source are configured to be changed.

27. The light source assembly of claim 1, further comprising:
an operation panel; and
memory,
wherein the control unit is configured to store information on selection of paper size which respective user selects in the memory; and
wherein the control unit is configured to prompt user to initiate the illumination of the scan boundary, via the operation panel, only when the control unit determines a paper size which the user has not used is selected via the operation panel.

28. The light source assembly of claim 1, further comprising:
wherein the control unit is configured to access an external memory storage and to store information on selection of paper size which respective user selects in the external memory storage,
wherein the external memory storage is configured to be accessed by a control unit of a plurality of light source assemblies,
wherein the control unit is configured to prompt user to initiate the illumination of the scan boundary, via the operation panel, only when the control unit determines a paper size which the user has not used is selected via the operation panel, based on a usage information for the respective user, the usage information being stored in the external storage and being collected from the plurality of light source assemblies.
